(19) United States
(12) Patent Application Publication
(10) Pub. No.: US 2018/0067709 A1
(43) Pub. Date: Mar. 8, 2018

(54) CONTROL DEVICE, IMAGE FORMING SYSTEM, AND NON-TRANSITORY RECORDING MEDIUM

(71) Applicant: Atsushi SAKAUE, Kanagawa (JP)

(72) Inventor: Atsushi SAKAUE, Kanagawa (JP)

(21) Appl. No.: 15/695,531

(22) Filed: Sep. 5, 2017

(30) Foreign Application Priority Data
Sep. 5, 2016 (JP) 2016-172482
Sep. 4, 2017 (JP) 2017-169738

(51) Int. Cl. G06F 3/12

(52) U.S. Cl. CPC G06F 3/1279; G06F 3/1237; G06F 3/1236

(57) ABSTRACT

A control device includes circuitry to generate a plurality of pieces of plain data corresponding to a plurality of colors of one page according to image data transferred from a higher-level device. The control device is connectable to an image forming apparatus via a single communication path or a plurality of communication paths. The circuitry sets a transfer request flag of one piece of plain data to a transfer requesting state when a serial transfer method is set as transfer method management information and sets transfer request flags of all pieces of plain data to the transfer requesting state when a parallel transfer method is set as the transfer method management information; and controls transfer of one piece or all pieces of plain data from the control device to the image forming apparatus according to a set state of the transfer request flags.

### CROSS-REFERENCE TO RELATED APPLICATIONS

This patent application is based on and claims priority pursuant to 35 U.S.C. § 119(a) to Japanese Patent Application Nos. 2016-172482, filed on Sep. 5, 2016, and 2017-169738, filed on Sep. 4, 2017, in the Japan Patent Office, the entire disclosure of each of which is hereby incorporated by reference herein.

### BACKGROUND

### Technical Field

Aspects of the present disclosure relate to a control device, an image forming system, and a non-transitory recording medium.

### Related Art

An image forming system is known that includes an image forming apparatus and a control device to transfer print data and instruct printing to the image forming apparatus. In such an image forming system, for example, a digital front end (DFE) server being a control device generates print image data by raster image processor (RIP) processing according to print data described in page description language (PDL) sent from a host device. The print image data consist of raster image data (plain data) corresponding to respective colors (for example, cyan, magenta, yellow, and black) of color material, such as ink or toner, of an image forming apparatus. The DFE server transfers the generated plain data to the control device of the image forming apparatus.

As another image forming system, for example, an image forming apparatus is also known that includes a printer controller, a printer engine, and a data line connecting the printer controller to the printer engine. In the image forming apparatus, a control line to send and receive various control information between the printer controller and the printer engine is separated from the data line to send and receive plain data to increase the data transfer speed.

### SUMMARY

In an aspect of the present disclosure, there is provided a control device connectable to an image forming apparatus. The control device includes circuitry to generate a plurality of pieces of plain data corresponding to a plurality of colors of one page, which is to be processed in the image forming apparatus, according to image data transferred from a higher-level device, the control device connectable to the image forming apparatus via a single communication path or a plurality of communication paths corresponding to the plurality of colors; send the plurality of pieces of plain data to the image forming apparatus; set, as transfer method management information, either a serial transfer method of executing transfer control of the plurality of pieces of plain data in unit of page through the single communication path or a parallel transfer method of executing independent parallel transfer controls for the plurality of pieces of plain data through the plurality of communication paths, according to information on which of the single communication path and the plurality of communication paths connects the control device to the image forming apparatus; set a transfer request flag of one piece of the plurality of pieces of plain data to a transfer requesting state when the serial transfer method is set as the transfer method management information and to set transfer request flags of all pieces of the plurality of pieces of plain data to the transfer requesting state when the parallel transfer method is set as the transfer method management information; and control transfer of one piece or all pieces of the plurality of pieces of plain data from the control device to the image forming apparatus according to a set state of the transfer request flags.

In another aspect of the present disclosure, there is provided an image forming system that includes the control device and the image forming apparatus connected to the control device. The image forming apparatus outputs an image according to the plurality of pieces of plain data transferred from the control device.

In still another aspect of the present disclosure, there is provided a method of controlling a control device connected to an image forming apparatus. The method includes generating a plurality of pieces of plain data corresponding to a plurality of colors of one page, which is to be processed in the image forming apparatus, according to image data transferred from a higher-level device, the control device connectable to the image forming apparatus via a single communication path or a plurality of communication paths corresponding to the plurality of colors; sending the plurality of pieces of plain data to the image forming apparatus; setting, as transfer method management information, either a serial transfer method of executing transfer control of the plurality of pieces of plain data in unit of page through the single communication path or a parallel transfer method of executing independent parallel transfer controls for the plurality of pieces of plain data through the plurality of communication paths, according to information on which of the single communication path and the plurality of communication paths connects the control device to the image forming apparatus; setting a transfer request flag of one piece of the plurality of pieces of plain data to a transfer requesting state when the serial transfer method is set as the transfer method management information; setting transfer request flags of all pieces of the plurality of pieces of plain data to the transfer requesting state when the parallel transfer method is set as the transfer method management information; and controlling transfer of one piece or all pieces of the plurality of pieces of plain data from the control device to the image forming apparatus according to a set state of the transfer request flags.

In still yet another aspect of the present disclosure, there is provided a recording medium storing program codes that cause a computer to perform the method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a block diagram of an example of an image forming system according to an embodiment of the present disclosure;

FIG. 2 is a block diagram of an example of a hardware configuration of a control device;

FIG. 3 is a functional block diagram of an example of functions of the control device;

FIG. 4 is an illustration of an example of page data management information;

FIG. 5 is an illustration of a state in which a data sending unit is connected to a printer via a single data line;

FIG. 6 is an illustration of a state in which the data sending unit is connected to the printer via a plurality of data lines;

FIG. 7 is an illustration of an example of page transfer management information;

FIG. 8 is an illustration of an example of plain-data management information;

FIG. 9 is a block diagram of a portion of a functional configuration of the control device;

FIG. 10A (consisting of FIGS. 10AA and 10AB) is a sequence diagram of an example of operation of a parallel transfer method in the image forming system;

FIG. 10B (consisting of FIGS. 10BA, 10BB, and 10BC) is a sequence diagram of an example of operation of a serial transfer method in the image forming system;

FIG. 11 is a flowchart of a flow of creation processing of page transfer management information in a device control request management unit in step S6 of each sequence of FIGS. 10A and 10B;

FIG. 12 is a flowchart of a flow of sending processing of a transfer request in the device control request management unit in step S9 of each sequence of FIGS. 10A and 10B;

FIG. 13 is a flowchart of a flow of processing in a page transfer request management unit in steps S10 and S11 of each sequence of FIGS. 10A and 10B;

FIG. 14 is a flowchart of a flow of plain transfer preparation processing in a plain transfer control unit in step S12 of each sequence of FIGS. 10A and 10B;

FIG. 15 is a flowchart of a flow of transfer processing of plain data in the plain transfer control unit in step S13 of each sequence of FIGS. 10A and 10B;

FIG. 16 is a flowchart of a flow of transfer processing of plain data of the next page in the plain transfer control unit in step S14 of each sequence of FIGS. 10A and 10B; and

FIGS. 17A and 17B illustrate a flowchart of a flow of processing in the page transfer request management unit in steps S15 and S16 of each sequence of FIGS. 10A and 10B.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Below, a control device, an image forming system, and a non-transitory recording medium according to embodiments of the present disclosure are described with reference to the attached drawings.

A description is given of an outline of production printing to which an image forming system including a control device according to an embodiment of the present disclosure is applied. For production printing, basically, it is assumed to perform high-volume printing in a short time. Therefore, for production printing, to increase the printing speed and effectively control, e.g., jobs and print data, a workflow system to control a process from the creation of print data to the distribution of print.

An image forming system according to an embodiment of the present disclosure relates to a section to perform printing in a workflow of production printing. Raster image processor (RIP) processing and printing of print image data consisting of a plurality of pieces of raster image data (plain data), which constitute page obtained by the RIP processing, are performed by different apparatuses. RIP processing requires largest processing time among various types of print processing. Therefore, separating the apparatus that performs RIP processing from the apparatus that performs print processing can increase the printing speed.

Outline of Image Forming System

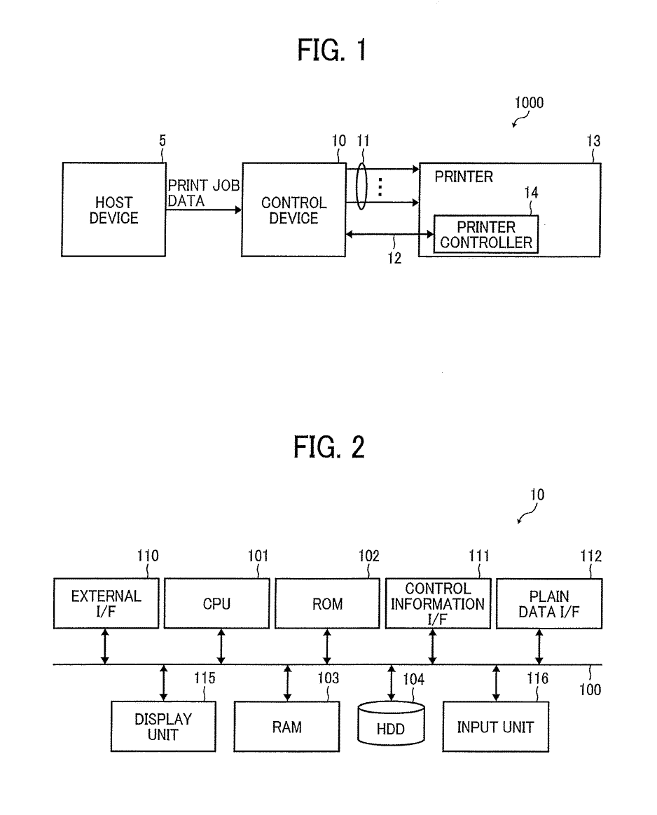

FIG. 1 is a block diagram of an example of an image forming system according to an embodiment of the present disclosure. As illustrated in FIG. 1, the image forming system 1000 includes a control device 10 being, e.g., a digital front end processor (DFE) server and a printer 13 as an image forming apparatus. The control device 10 and the printer 13 are connected to each other via data lines 11 and a control line 12. A host device 5 as higher-level device is, for example, a computer to generate print job data.

The print job data includes, for example, data in page description language (PDL) format (hereinafter, PDL data). The control device 10 interprets the PDL data to generate plain data constituting print image data for printing and printing control information relating to settings of printing, such as information on print page, layout, and the number of prints.

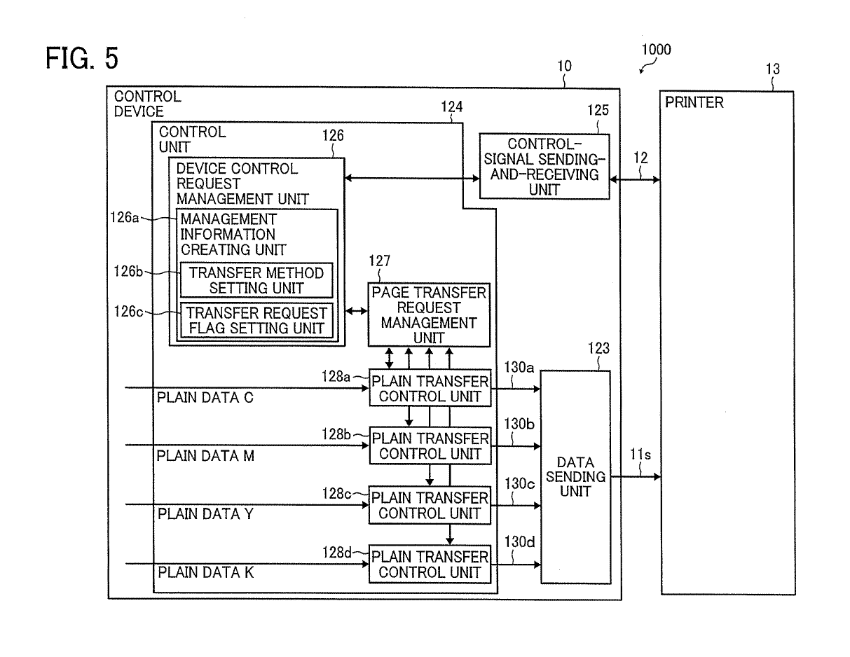

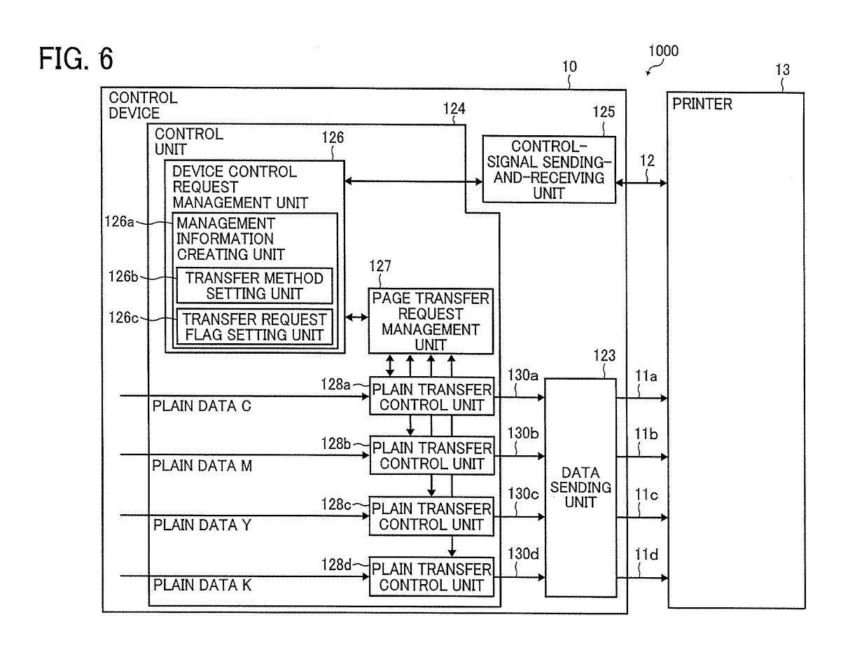

The data line 11 is a communication path through which plain data for each color created in the control device 10 is sent to the printer 13. The data line 11 may be a single serial communication path or a plurality of parallel communication paths. When the data line 11 is a single serial communication path, the single serial communication path is referred to as data line 11s (see FIG. 5). When the data line 11 is a plurality of parallel communication paths, the plurality of parallel communication paths are referred to as a plurality of data lines 11a to 11 d (see FIG. 6) corresponding to plain data for colors of cyan (C), magenta (M), yellow (Y), and black (K), respectively, generated in an image generating unit 121.

The control device 10 is a DFE server. The control device 10 performs RIP processing according to print job data supplied from the host device 5 and creates plain data of respective colors constituting print image data. The control device 10 also creates control information to control printing operation, based on, e.g., print job data and information from the host device 5.

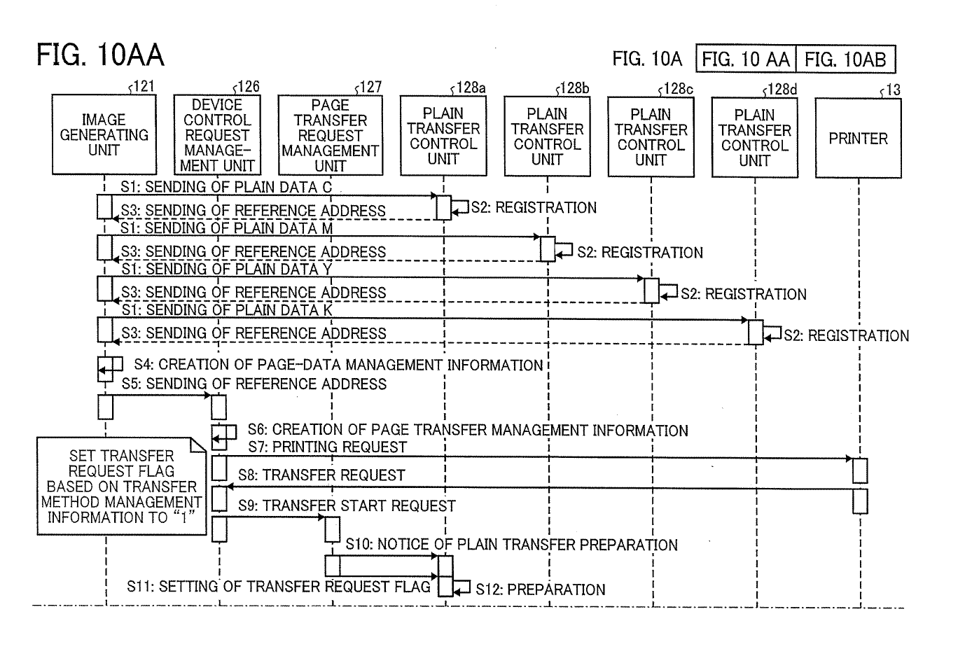

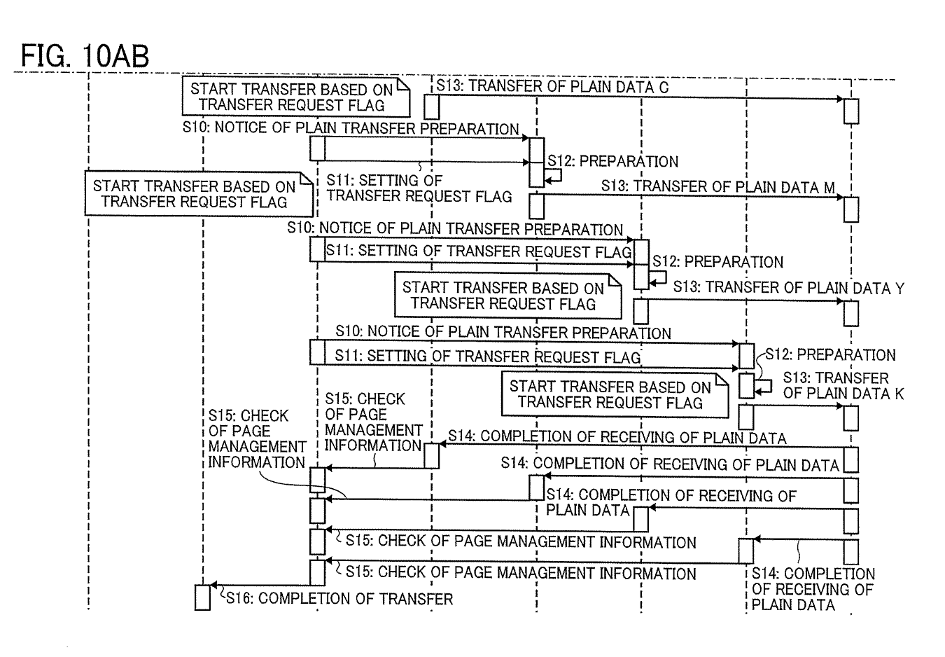

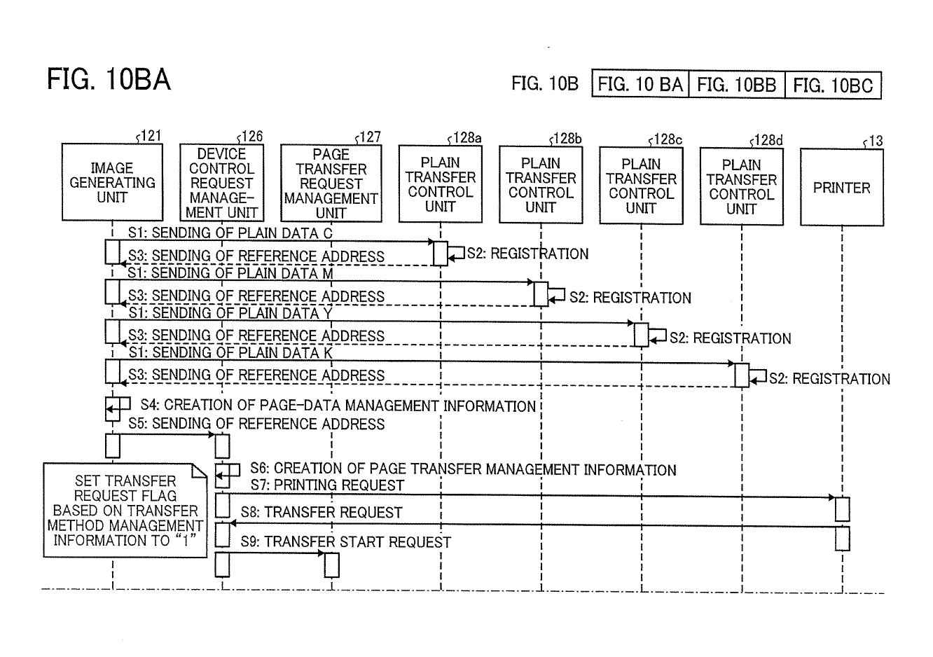

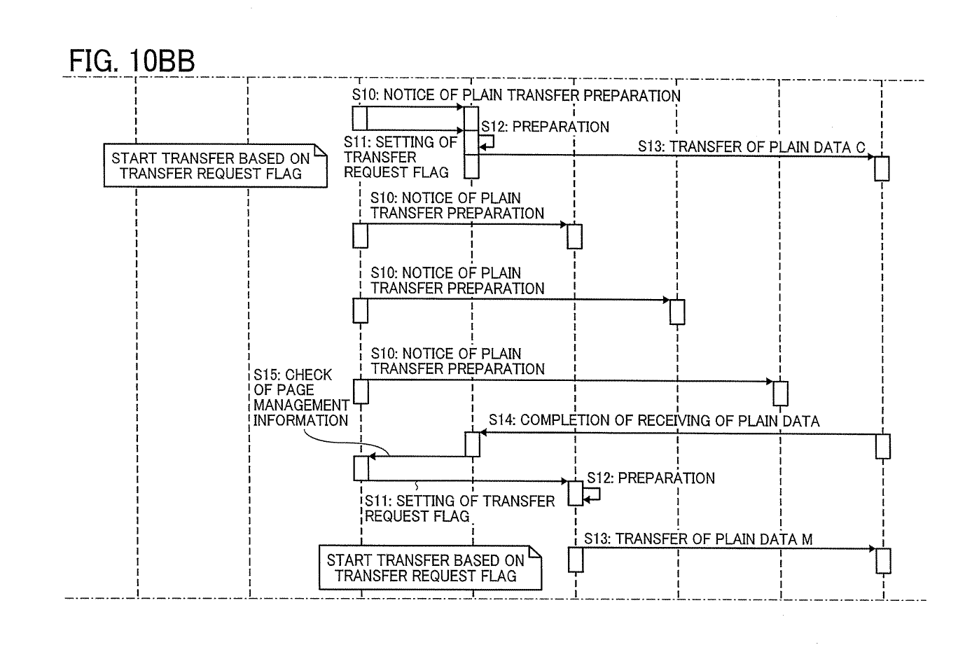

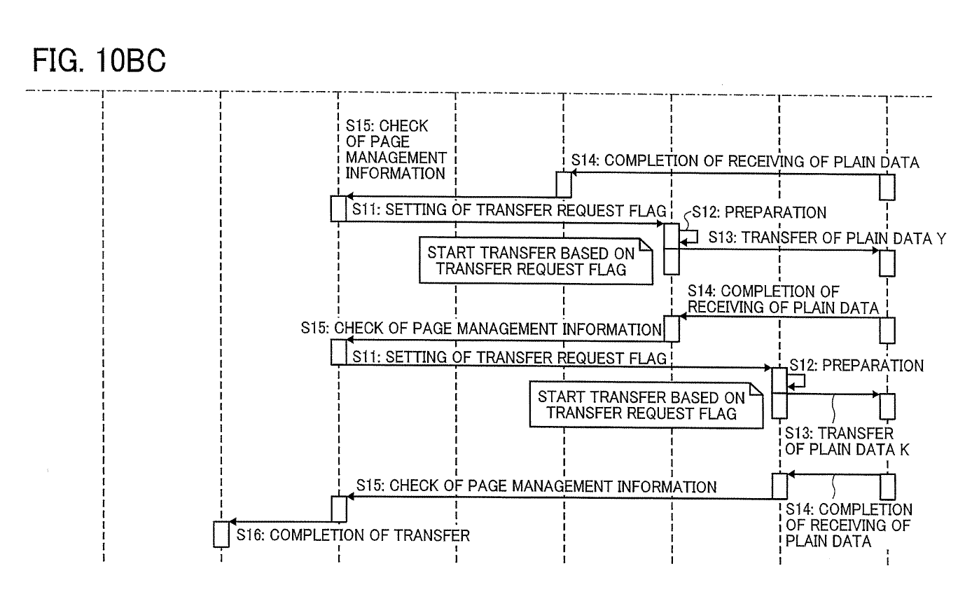

The plain data for each color generated in the control device 10 is supplied to a printer engine unit of the printer 13 via the data line 11. Sending and receiving of the control information to control printing are performed between the control device 10 and a printer controller 14 via the control line 12. The printer controller 14 controls the printer engine unit based on sending and receiving of the control information to performs image formation on a print medium according to the plain data. Note that an example of the control information is described later with reference to, e.g., FIG. 10.

Although the printing method is not limited to any particular printing method, in the present embodiment, a print sheet of paper is used as the print medium and a print image is formed on the print sheet by an inkjet method. However, the printing method is not limited to the inkjet method. The present embodiment may be applied to a printing apparatus that forms a print image on a print sheet by, for example, an electrophotographic method using toner.

As the print sheet, in the present embodiment, continuous-form paper (continuous form) being continuous paper in which cuttable stitch perforations are formed at certain intervals. In production printing, continuous-form paper is often used as print sheet. The print sheet is not limited to the continuous-form paper. For example, a cut sheet of paper of a fixed size, such as A4-size and B-4 size, may be used as print sheet. Note that, in the continuous-form paper, the term “page” means an area interposed between stitch perforations formed at certain intervals.

Note that the print medium being a print target of an image forming system according to the present embodiment is not limited to a print sheet of paper. In other words, any other print medium can be used if the print medium is printable according to a print method applied to the present embodiment and provided as a roll. For example, plastic film or cloth can be used as the print medium.

Control Device

Next, the control device 10 is described below.

FIG. 2 is a block diagram of an example of a hardware configuration of the control device 10. As illustrated in FIG. 2, the control device 10 includes a central processing unit (CPU) 101. The CPU 101 is connected to a read only memory (ROM) 102, a random access memory (RAM) 103, and a hard disk drive (HDD) 104 via a bus 100. The CPU 101 is connected to an external interface (I/F) 110, a control information I/F 111, a plain data I/F 112, a display unit 115, and an input unit 116 via the bus 100. The above-described components connected to the bus 100 can be communicated with each other via the bus 100.

The ROM 102 and the HDD 104 store programs that causes the CPU 101 to operate. The RAM 103 is used as a working memory of the CPU 101. In other words, according to the programs stored in the ROM 102 and the HDD 104, the CPU 101 controls operations of the entire control device 10 by using the RAM 103 as the working memory. The display unit 115 includes a display element, such as a liquid crystal display (LCD) and a driver to drive the display element. The display unit 115 performs display according to an instruction of the CPU 101. The input unit 116 receives a user's operation and outputs a control signal in response to the user's operation.

The external I/F 110 supports a transmission control protocol/Internet protocol (TCP/IP) and controls communication with the host device 5.

The plain data I/F 112 controls communication of plain data. For example, when the data lines 11a to 11d (see FIG. 6) being a plurality of parallel communication paths are used as the data line 11, the plain data I/F 112 has a plurality of channels. For example, plain data for each color of C, M, Y, and K, which are generated in the control device 10, is output from a corresponding one of the plurality of channels. Since the plain data I/F 112 requires for high-speed transfer speed, a high-speed I/F, such as Fibre Channel or 10 Gigabit Ethernet (registered trademark), is used for the plain data I/F 112.

Note that, when the data line 11 is the data line 11s (see FIG. 5) being a single serial communication path, the plain data I/F 112 has a single channel.

The control information I/F 111 controls communication of the control information. The transfer method of the control information I/F 111 is not limited to any particular method. However, since a transfer speed as fast as the transfer speed of plain data is not required for the control information I/F 111, for example, Gigabit Ethernet (registered trademark) can be used.

With such a configuration, the print job data sent from the host device 5 is received by the external I/F 110 of the control device 10 and stored in the HDD 104 via the CPU 101. The CPU 101 performs RIP processing according to print job data read from the HDD 104, generates print image data consisting of plain data of respective colors, and writes the print image data onto the RAM 103. For example, the CPU 101 renders PDL data by RIP processing, generates print image data constituted by plain data of respective colors, and writes the print image data onto the RAM 103. The CPU 101 compresses and encodes the print image data constituted by plain data of the respective colors written on the RAM 103, and temporarily the compressed and encoded print image data onto the HDD 104.

For example, when printing operation is started in the printer 13, the CPU 101 reads the compressed and encoded print image data constituted by plain data of respective colors from the HDD 104, decompresses and decodes the compressed and encoded print image data constituted by the plain data of respective colors, and writes the decompressed print image data constituted by the plain data of respective colors onto the RAM 103. The CPU 101 reads the print image data constituted by the plain data of respective colors from the RAM 103, outputs the plain data of each color from each channel of the plain data I/F 112 to supply the print image data to the printer 13. The CPU 101 sends and receives the control information to control printing to and from the printer 13 via the control information I/F 111, according to, e.g., a progress of printing operation. Note that, to complete the data transfer at high speed, the compressed and encoded print image data constituted by plain data of respective colors may be directly transferred to the printer 13 without being decoded and may be decompressed in the printer 13. For example, when the data line 11s (see FIG. 5) being a single serial communication path is used as the data line 11, the compressed and encoded bitmap data may be decompressed in the printer 13 to increase the transfer efficiency.

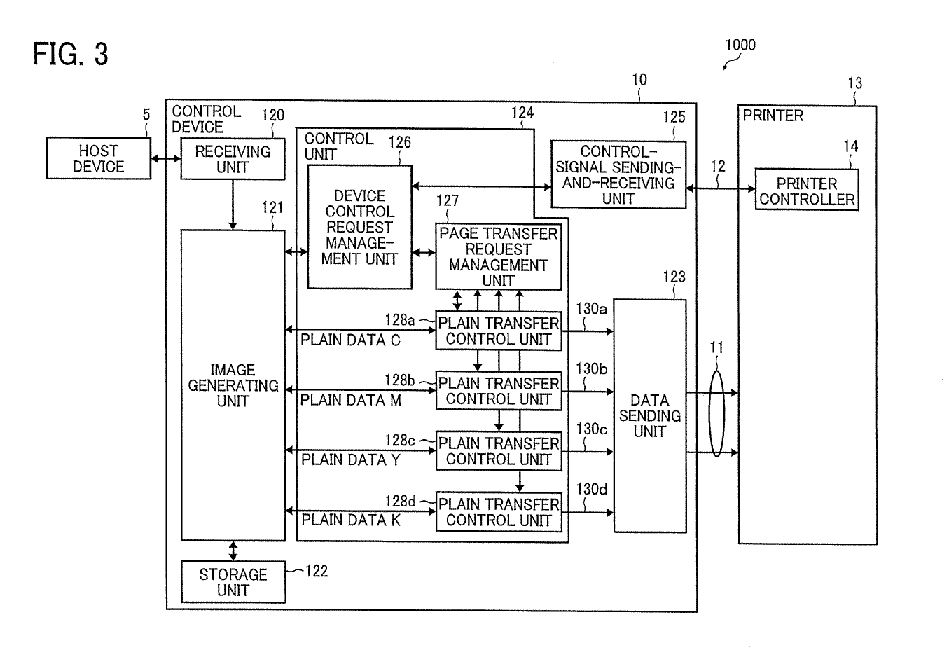

FIG. 3 is a functional block diagram of an example of functions of the control device 10. The control device 10 includes a receiving unit 120, the image generating unit 121, a storage unit 122, a data sending unit 123, a control unit 124, and a control-signal sending-and-receiving unit 125. The receiving unit 120, the data sending unit 123, and the control-signal sending-and-receiving unit 125 correspond to the external I/F 110, the plain data I/F 112, and the control information I/F 111, respectively, illustrated in FIG. 2. The image generating unit 121 and the control unit 124 are constructed by programs that operate on the CPU 101 illustrated in FIG. 2. The storage unit 122 corresponds to at least one of the RAM 103 and the HDD 104 illustrated in FIG. 2.

The print job data including PDL data is generated in the host device 5 and sent to the control device 10. The print job data is received by the receiving unit 120 and supplied to the image generating unit 121. The image generating unit 121 performs rendering based on the PDL data included in the supplied print job data and the rendered data is converted into data in a format processable in the printer 13. The image generating unit 121 typically generates plain data of each color of C, M, Y, and K. The image generating unit 121 stores the generated plain data for each color of C, M, Y, and K in turn onto the storage unit 122. Note that, depending on the capability of the printer 13, the plain data may be separated into color components other than C, M, Y, and K.

As illustrated in FIG. 3, the image generating unit 121 generates plain data for each color of C, M, Y, and K per page (plain data C, plain data M, plain data Y, and plain data K).

The image generating unit 121 sends the generated plain data per page to plain transfer control units 128a through 128d. The plain transfer control units 128a through 128d generate and register plain-data management information 70 (see FIG. 8) corresponding to each plain data sent from the image generating unit 121. The plain-data management information 70 is further described later. The plain transfer control units 128a through 128d send, to the image generating unit 121, reference address (head address of the memory region) of page transfer management information 60 in the registered plain-data management information 70.

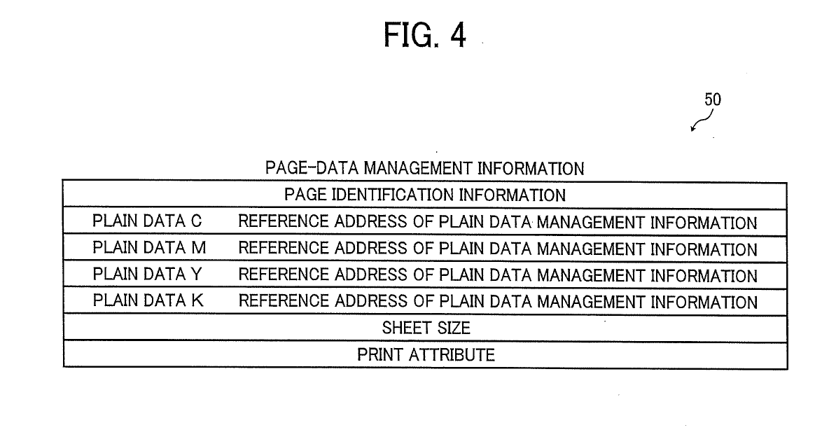

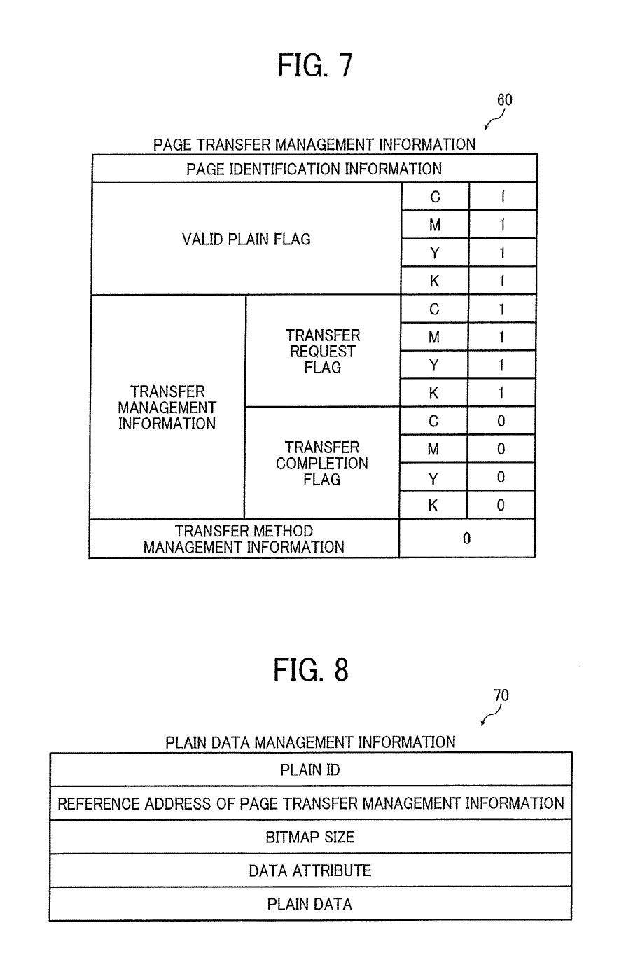

When the image generating unit 121 receives the reference address (head address of the memory region) of the page transfer management information 60 from the plain transfer control units 128a through 128d, the image generating unit 121 creates the page-data management information 50 (see FIG. 4) and sends reference address of the created page-data management information 50 to the control unit 124. The page-data management information 50 is further described later. The control unit 124 creates the page transfer management information 60 (see FIG. 7) based on the reference address of the page-data management information 50 sent from the image generating unit 121. The page transfer management information 60 is further described later.

FIG. 4 is an illustration of an example of the page-data management information 50. As illustrated in FIG. 4, the page-data management information 50 includes the reference addresses of the plain-data management information 70 for the respective plain data (plain data C, plain data M, plain data Y, and plain data K), sheet size, and print attribute for each page identification information that is information for identifying a page. Note that the page-data management information 50 may include not only sheet size but also other information on, for example, a sheet feeding source or a sheet ejected destination.

Note that, in the present embodiment, plain data of C, M, Y, and K are used. However, the colors of plain data are not limited to C, M, Y, and K but may include any other special color, such as clear color, white, orange, and green.

The control unit 124 performs communication with the printer controller 14 of the printer 13 via the control-signal sending-and-receiving unit 125. For example, the control unit 124 generates control information on transfer of plain data for each color of C, M, Y, and K to and from the printer 13, based on print job data supplied from the host device 5 via the receiving unit 120. The control information is sent from the control unit 124 to the printer controller 14 via the control-signal sending-and-receiving unit 125.

The data sending unit 123 is connected to the printer 13 via the data line 11. The data sending unit 123 transfers, via the data line 11, the plain data for each color of C, M, Y, and K stored in the storage unit 122.

Here, the control unit 124 is further described below. The control unit 124 includes a device control request management unit 126, a page transfer request management unit 127, and the plain transfer control units 128a through 128d.

The plain transfer control units 128a through 128d control transfer of the above-described four pieces of plain data (plain data C, plain data M, plain data Y, and plain data K). The plain transfer control unit 128a controls transfer of the plain data C. The plain transfer control unit 128b controls transfer of the plain data M. The plain transfer control unit 128c controls transfer of the plain data Y. The plain transfer control unit 128d controls transfer of the plain data K.

FIG. 5 is an illustration of a state in which the data sending unit 123 is connected to the printer 13 via the single data line 11s. As illustrated in FIG. 5, when the data sending unit 123 is connected to the printer 13 via the single data line 11s, the plain transfer control units 128a through 128d perform transfer control in unit of page to serially send the plane data to the printer 13 via the data sending unit 123 and the data line 11s. In such a case, only one communication path of the communication paths 130a, 130b, 130c, and 130d between the data sending unit 123 and each of the plain transfer control units 128a through 128d is used, and the other communication paths cannot be used.

FIG. 6 is an illustration of a state in which the data sending unit 123 is connected to the printer 13 via the plurality of data lines 11a to 11d. As illustrated in FIG. 6, when the data sending unit 123 is connected to the printer 13 via the plurality of data lines 11a to 11d, the plain transfer control units 128a through 128d send the plane data to the printer 13 via the data sending unit 123 and the plurality of data lines 11a to 11d. In such a case, all of the communication paths 130a, 130b, 130c, and 130d between the data sending unit 123 and the plain transfer control units 128a through 128d are used. The plain transfer control units 128a through 128d execute independent parallel transfer controls for respective pieces of plain data, which operate in parallel.

The device control request management unit 126 manages various requests that are sent and received by the control device 10. For example, the device control request management unit 126 confirms, through information exchange with the printer 13, that the printer 13 can perform printing operation, and outputs a printing request to the printer 13 via the control-signal sending-and-receiving unit 125. In response to the printing request, the device control request management unit 126 receives a page transfer request from the printer 13 via the control-signal sending-and-receiving unit 125.

In addition, the device control request management unit 126 includes a management data creating unit 126a. The management data creating unit 126a creates the page transfer management information 60 (see FIG. 7) according to the reference address of the page-data management information 50 sent from the image generating unit 121. The device control request management unit 126 manages information for the page transfer management information 60 created by the management data creating unit 126a. As illustrated in FIGS. 5 and 6, the management data creating unit 126a includes a transfer method setting unit 126b and a transfer request flag setting unit 126c.

The transfer method setting unit 126b sets, as transfer method management information (see FIG. 7), one of the serial transfer method of executing transfer control of plain data in unit of page through the single data line 11s and the parallel transfer method of executing independent parallel transfer controls for respective pieces of plain data through the plurality of data lines 11a to 11d, based on information on which of the single data line 11s and the plurality of data lines 11a to 11d is (are) used to connect the data sending unit 123 to the printer 13.

When the transfer method management information is the serial transfer method, the transfer request flag setting unit 126c sets a transfer request flag (see FIG. 7) for requesting transfer of one piece of plain data to “1”. When the transfer method management information is the parallel transfer method, the transfer request flag setting unit 126c sets a transfer request flag for requesting transfer of all pieces of plain data to “1”.

FIG. 7 is an illustration of an example of the page transfer management information 60. As illustrated in FIG. 7, the page transfer management information 60 includes, for each page identification information, valid plain flags of the respective pieces of plain data (plain data C, plain data M, plain data Y, and plain data K), transfer management information of the respective pieces of plain data (plain data C, plain data M, plain data Y, and plain data K), and the transfer method management information.

The valid plain flag indicates that it is necessary to send each plain data (of plain data C, plain data M, plain data Y, and plain data K). In other words, the value “1” of the valid plain flag indicates that there is the corresponding plain data and it is necessary to send the plain data. When the valid plain flag is “0”, the sending of plain data is invalid.

The transfer management information includes transfer request flags and transfer completion flags of plain data (of plain data C, plain data M, plain data Y, and plain data K). The value “1” of the transfer request flag indicates that data sending processing of the corresponding plain data is to be started. The value of “1” of the transfer completion flag indicates that data sending of the corresponding plain data has been completed by the plain transfer control units 128a through 128d.

The transfer method management information is a transfer method flag to control a transfer method and is specified by information exchange with the printer 13 on start-up. For example, the value “0” of the transfer method flag indicates a state in which the control device 10 is connected to the printer 13 through the plurality of data lines 11a to 11d and that the transfer method is the parallel transfer method of executing independent parallel transfer controls for respective pieces of plain data. The value “1” of the transfer method flag indicates a state in which the control device 10 is connected to the printer 13 through the single data line 11s and that the transfer method is the serial transfer method of executing transfer control of plain data in unit of page.

In other words, when the transfer method is the parallel transfer method of transferring respective pieces of plain data in parallel, the device control request management unit 126 sets all transfer request flags for valid plain data to “1” in creating the page transfer management information 60. Such setting allows the transfer of plain data to be executed in parallel.

Meanwhile, when the transfer method is the serial transfer method of serially transferring respective pieces of plain data, the device control request management unit 126 sets the transfer request flag to “1” by receiving a request in unit of plain data from the printer 13 as a trigger. Alternatively, the device control request management unit 126 sets the transfer request flag to “1” in a predetermined transfer order by receiving a request in unit of page from the printer 13 as a trigger.

In both cases, the device control request management unit 126 receives the trigger. Such a configuration allows the device control request management unit 126 to control the start of transfer according to a page printing request designating plain data to be transferred next.

As described above, the transfer method is changed according to the transfer method flag. The serial transfer method of executing transfer control of plain data in unit of page and the parallel transfer method of executing independent parallel transfer controls for respective pieces of plain data are supported without changing the structure of control programs.

The device control request management unit 126 utilizes the reference address of the plain-data management information 70 on each plain data of the page-data management information 50 sent from the image generating unit 121, to set the reference address of the page transfer management information 60 created for the plain-data management information 70 (see FIG. 8).

The device control request management unit 126 also send the created page transfer management information 60 to the page transfer request management unit 127.

The page transfer request management unit 127 manages the page transfer management information 60 sent from the device control request management unit 126, by utilizing the data structure of FIFO queue. The page transfer request management unit 127 retrieves the page transfer management information 60 according to first-in first-out from the page transfer management information 60 registered utilizing the data structure of FIFO queue

The plain transfer control units 128a through 128d register information to the plain-data management information 70 associated with the reference address of the plain-data management information 70 for each plain data of the page-data management information 50 sent from the image generating unit 121.

FIG. 8 is an illustration of an example of the plain-data management information 70. As illustrated in FIG. 8, the plain-data management information 70 includes the reference address of the page transfer management information 60, the bitmap size of the plain data, the data attribute of the plain data, and the plain data, for each of plain IDs identifying respective pieces of plain data (plain data C, plain data M, plain data Y, and plain data K).

The plain transfer control units 128a through 128d send, to the image generating unit 121, the reference address of the page transfer management information 60 in the created and registered plain-data management information 70.

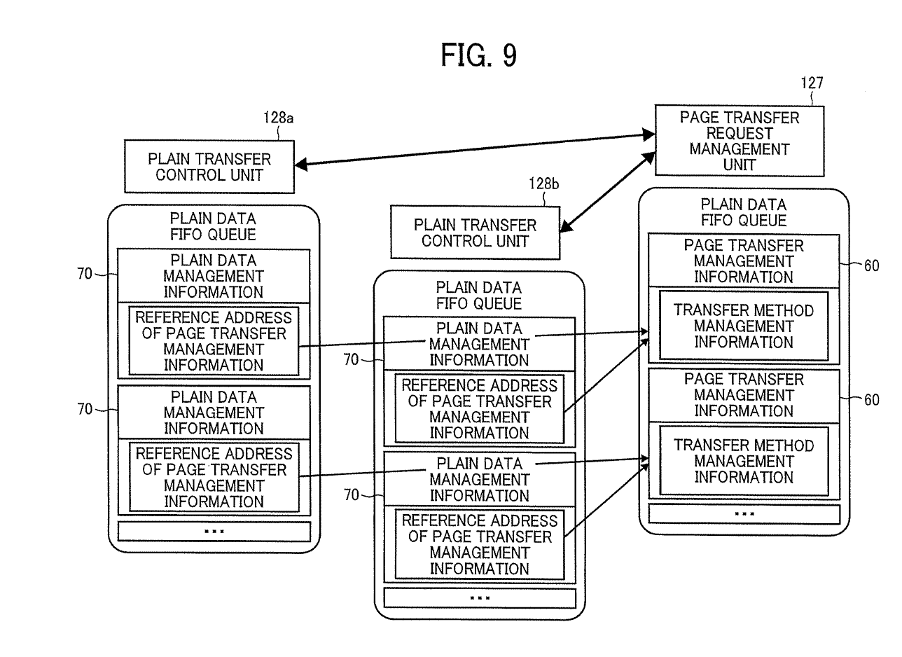

FIG. 9 is a block diagram of a portion of a functional configuration of the control unit 124. As illustrated in FIG. 9, the plain transfer control units 128a through 128d, though only the plain transfer control units 128a and 128b are illustrated in FIG. 9, utilizes a data structure of First In First Out (FIFO) queue secured in a memory region of the RAM 103 to register the plain-data management information 70. The FIFO queue stores an order of entry and exit. Regardless of any set of elements entering a queue, the earlier an element enters the queue, the earlier the element is processed and exits from the queue. The later an element enters a queue, the later the element is processed and exits from the queue. In other words, as an element enters a queue later, the element is processed and exits from the queue later than an element entering earlier. As described above, managing first-in first-out of data with FIFO queue can simplify the order control.

The plain-data management information 70 includes the reference address of the page transfer management information 60 as illustrated in FIG. 8.

The page transfer request management unit 127 utilizes the data structure of FIFO queue to register the page transfer management information 60. As illustrated in FIG. 7, the page transfer management information 60 includes the transfer management information on each plain data and the transfer method management information per page identification information. The page transfer management information 60 manages transfer request and transfer completion of each plain data (of plain data C, plain data M, plain data Y, and plain data K) linked with the reference address of the page transfer management information 60.

The page transfer request management unit 127 retrieves the page transfer management information 60 according to first-in first-out from the page transfer management information 60 registered utilizing the data structure of FIFO queue The page transfer request management unit 127 controls the plain transfer control units 128a through 128d and sends each plain data (of plain data C, plain data M, plain data Y, and plain data K) linked via the reference address of the retrieved page transfer management information 60 through the data line 11 according to the transfer method management information.

Example of Operation in Image Forming System

Next, an example of operation in the image forming system according to the present embodiment.

FIG. 10A (consisting of FIGS. 10AA and 10AB) is a sequence diagram of an example of operation of the parallel transfer method in the image forming system. FIG. 10B (consisting of FIGS. 10BA, 10BB, and 10BC) is a sequence diagram of an example of operation of the serial transfer method in the image forming system. Note that, in each of FIG. 10A and FIG. 10B, a case is illustrated in which one page includes plain data of C, M, Y, and K.

As illustrated in FIGS. 10A and 10B, the image generating unit 121 generates plain data (plain data C, plain data M, plain data Y, and plain data K) for each color of C, M, Y, and K per page, and sends the plain data to the plain transfer control units 128a through 128d (step S1).

The plain transfer control units 128a through 128d creates and registers the plain-data management information 70 illustrated in FIG. 8 onto a memory region of the RAM 103 by utilizing the data structure of FIFO queue (step S2). The plain transfer control units 128a through 128d return, to the image generating unit 121, the reference address (the head address of the memory region) of the page transfer management information 60 in the plain-data management information 70 of the FIFO queue (step S3).

The image generating unit 121 receives the reference address and creates the page-data management information 50 illustrated in FIG. 4 (step S4). For example, the image generating unit 121 puts information, such as a sheet size, a sheet feeding source, and a sheet ejected destination, required for a printing request together the reference address of the plain-data management information 70 of one sheet (corresponding to one page of single side or two pages of double sides) when data corresponding to one sheet are prepared.

Next, the image generating unit 121 sends the reference address of the created page-data management information 50 to the device control request management unit 126 (step S5).

The device control request management unit 126 executes the creation processing of the page transfer management information 60 illustrated in FIG. 7 according to the reference address of the page-data management information 50 sent from the image generating unit 121 (step S6). For example, the device control request management unit 126 creates one piece or two pieces of the page transfer management information 60 corresponding to one page of single side or two pages of doubles sides, respectively, from the page-data management information 50.

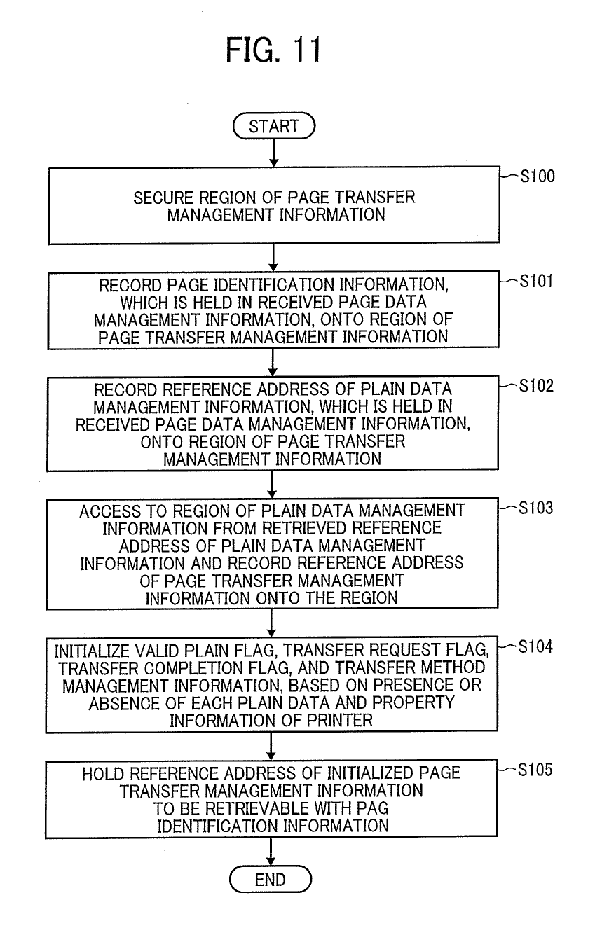

FIG. 11 is a flowchart of a flow of the creation processing of the page transfer management information 60 in the device control request management unit 126 in step S6 of each sequence of FIGS. 10A and 10B. As illustrated in FIG. 11, the device control request management unit 126 secures a region of the page transfer management information 60 in a memory region of the RAM 103 (step S100).

Next, the device control request management unit 126 records the page identification information, which is held in the received page-data management information 50 of the reference address received at the step S5, onto the region of the page transfer management information 60 (step S101).

Next, the device control request management unit 126 records a reference address of the plain-data management information 70, which is held in the received page-data management information 50 of the reference address received at the step S5, onto the region of the page transfer management information 60 (step S102).

Next, the device control request management unit 126 accesses to a region of the plain-data management information 70 of each plain data from the reference address of the retrieved plain-data management information 70 and records the reference address of the page transfer management information 60 onto the region of the plain-data management information 70 of each plain data (step S103).

Next, for the page transfer management information 60 illustrated in FIG. 7, the device control request management unit 126 (the transfer method setting unit 126b) initializes the valid plain flag, the transfer request flag, the transfer completion flag, and the transfer method management information according to the presence or absence of each plain data and the property information of the printer 13 (step S104).

Here, the device control request management unit 126 (the transfer request flag setting unit 126c) sets a flag of a transfer request according to the transfer method management information of the page transfer management information 60.

For example, when the transfer method of the printer 13 is the parallel transfer method of transferring a plurality of pieces of plain data in parallel, the device control request management unit 126 (the transfer request flag setting unit 126c) sets the transfer method flag of the transfer method management information to “0” and the transfer request flags of all pieces of the valid plain data to “1”. The device control request management unit 126 (the transfer request flag setting unit 126c) also sets the transfer completion flags of all pieces of the valid plain data to “0”.

For example, when the transfer method of the printer 13 is the serial transfer method of serially transfer a plurality of pieces of plain data one by one, the device control request management unit 126 (the transfer request flag setting unit 126c) sets the transfer method flag of the transfer method management information to “1” and the transfer request flag to “1” by receiving a request in unit of single piece of plain data from the printer 13 as a trigger. Alternatively, the device control request management unit 126 (the transfer request flag setting unit 126c) sets the transfer request flag to “1” in a predetermined transfer order by receiving a request in unit of page from the printer 13 as a trigger. The device control request management unit 126 (the transfer request flag setting unit 126c) also sets the transfer completion flags of all pieces of the valid plain data to “0”.

Finally, the device control request management unit 126 holds the reference address of the created and initialized page transfer management information 60 to be retrievable with the page identification information (step S105).

Thus, the creation processing of page transfer management information in the step S6 of the sequence of each of FIGS. 10A and 10B is terminated.

In FIG. 10A or 10B, the device control request management unit 126 receives information indicating that printing operation of the printer 13 is executable, and sends a printing request in unit of one sheet to the printer 13 (step S7). The printing request includes the page identification information.

The printer 13 sends a page transfer request including the page identification information at a proper timing. The device control request management unit 126 receives the page transfer request from the printer 13 (step S8).

The device control request management unit 126 also sends the transfer request to the page transfer request management unit 127 (step S9).

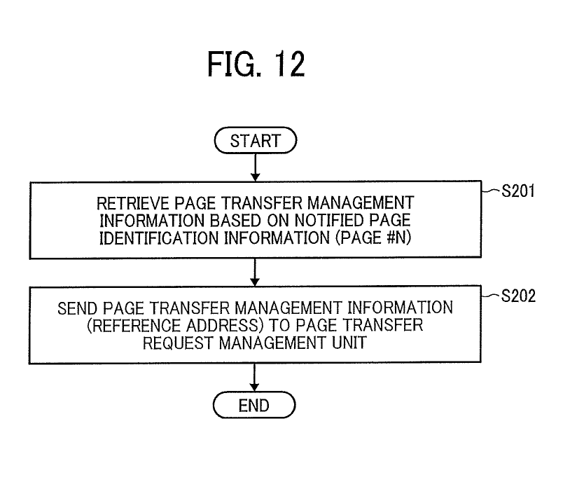

FIG. 12 is a flowchart of a flow of sending processing of the transfer request in the device control request management unit 126 in step S9 of each sequence of FIGS. 10A and 10B. As illustrated in FIG. 12, the device control request management unit 126 extracts the page transfer management information 60 according to the page identification information (page #N), which is included in the page transfer request notified from the printer 13 (step S201).

Next, the device control request management unit 126 sets, to each plain-data management information 70, the page transfer management information 60 (the reference address) created at the step S102 of FIG. 11 and sends the page transfer management information 60 (the reference address) to the page transfer request management unit 127 (step S202).

Thus, the sending processing of the transfer request in the step S9 of each sequence of FIGS. 10A and 10B is terminated.

In FIG. 10A or 10B, receiving the transfer request, the page transfer request management unit 127 executes plain transfer preparation processing (step S10) and executes setting processing of a plain transfer request flag (step S11).

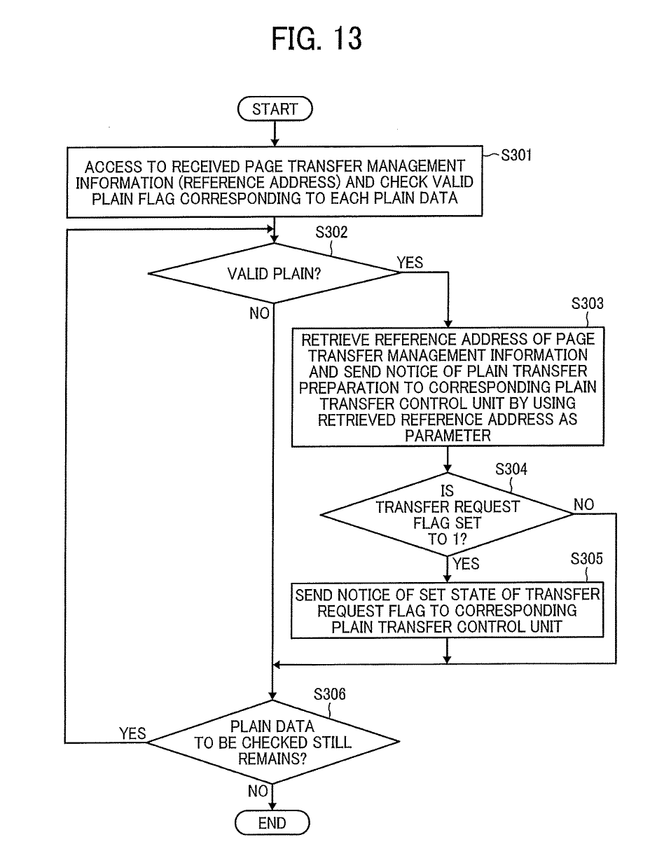

FIG. 13 is a flowchart of a flow of processing in the page transfer request management unit 127 in the steps S10 and S11 of each sequence of FIGS. 10A and 10B. As illustrated in FIG. 13, the page transfer request management unit 127 accesses to the received page transfer management information 60 (the reference address) and checks a valid plain flag corresponding to each plain data (step S301).

When the valid plain flag of the plain data of the page transfer management information 60 is “1” (YES at step S302), the page transfer request management unit 127 retrieves the reference address of the page transfer management information 60 and sends a notice of plain transfer preparation to the corresponding one of the plain transfer control units 128a through 128d by referring to the reference address of the plain management information as a parameter (step S303).

When the valid plain flag of the plain data of the page transfer management information 60 is “0” (NO at step S302), the page transfer request management unit 127 directly proceeds to step S306.

The page transfer request management unit 127 checks whether the transfer request flag of valid plain data in the page transfer management information 60 is set to “1” by the creation processing of the page transfer management information 60 in the device control request management unit 126 (the transfer request flag setting unit 126c) in the step S6 (step S304).

When the transfer request flag is set to “1” (YES at step S304), the page transfer request management unit 127 sends a notice of a set state of the transfer request flag to a corresponding one of the plain transfer control units 128a through 128d (step S305) and proceeds to step S306.

When the transfer request flag is not set to “1” (NO at step S304), the page transfer request management unit 127 directly proceeds to the step S306.

In the step S306, the page transfer request management unit 127 checks whether plain data to be checked still remains (step S306).

When the plain data to be checked still remains (YES at the step S306), the page transfer request management unit 127 returns to the step S302. Alternatively, when the plain data to be checked does not remain (NO at the step S306), the page transfer request management unit 127 terminates the processing.

Thus, the processing in the steps S10 and S11 of each sequence of FIGS. 10A and 10B ends.

In FIG. 10A or 10B, the plain transfer control units 128a through 128d execute the plain transfer preparation processing (step S12).

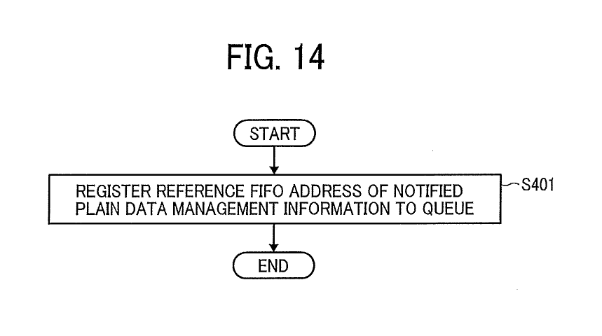

FIG. 14 is a flowchart of a flow of the plain transfer preparation processing in the plain transfer control units 128a through 128d in the step S12 of each sequence of FIGS. 10A and 10B. As illustrated in FIG. 14, each of the plain transfer control units 128a through 128d registers the reference address of the notified plain-data management information 70 onto the FIFO queue (step S401) and terminates the processing.

Thus, the plain transfer preparation processing in the plain transfer control units 128a through 128d in the step S12 of each sequence of FIGS. 10A and 10B ends.

In FIG. 10A or 10B, each of the plain transfer control units 128a through 128d executes transfer processing of plain data (step S13).

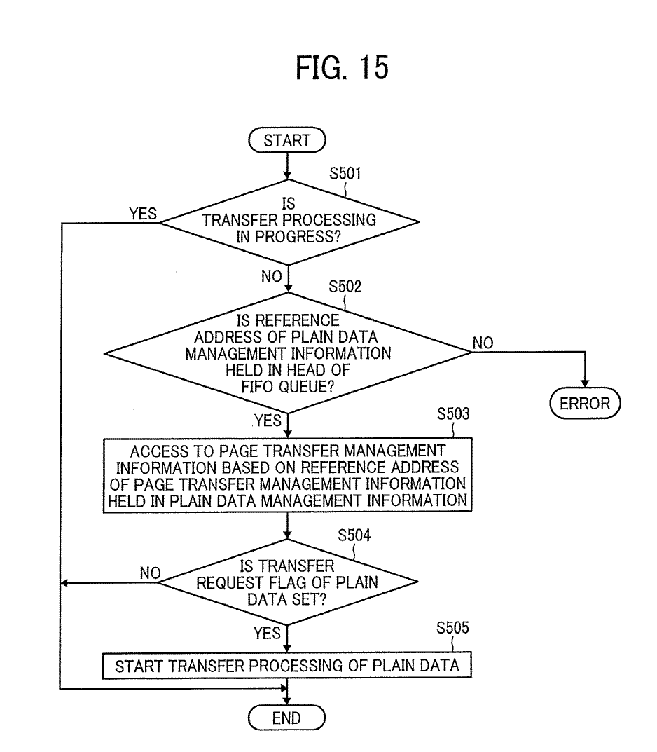

FIG. 15 is a flowchart of a flow of transfer processing of plain data in the plain transfer control units 128a through 128d in the step S13 of each sequence of FIGS. 10A and 10B.

As illustrated in FIG. 15, each of the plain transfer control units 128a through 128d checks whether the transfer processing of plain data is in progress (step S501).

When each of the plain transfer control units 128a through 128d determines that the transfer processing of plain data is in progress (YES at step S501), each of the plain transfer control units 128a through 128d terminates the processing.

Alternatively, when each of the plain transfer control units 128a through 128d determines that the transfer processing of plain data is not in progress (NO at step S501), each of the plain transfer control units 128a through 128d checks whether the reference address of the plain-data management information 70 is held in the head of the FIFO queue (step S502).

Next, when the reference address of the plain-data management information 70 is held in the head of the data structure of the FIFO queue (YES at the step S502), each of the plain transfer control units 128a through 128d accesses to the page transfer management information 60 according to the reference address of the page transfer management information 60 held in the plain-data management information 70 (step S503).

Note that when the reference address of the plain-data management information 70 is not held in the head of the data structure of the FIFO queue (NO at the step S502), each of the plain transfer control units 128a through 128d determines that it is an error and terminates the processing.

Next, each of the plain transfer control units 128a through 128d checks the transfer request flag of the page transfer management information 60 (step S504).

When the transfer request flag of the page transfer management information 60 is “0” (NO at the step S504), each of the plain transfer control units 128a through 128d terminates the processing.

Alternatively, when the transfer request flag of the page transfer management information 60 is “1” (YES at the step S504), each of the plain transfer control units 128a through 128d starts the transfer processing of plain data (step S505).

Thus, the transfer processing of plain data in each of the plain transfer control units 128a through 128d in the step S13 of each sequence of FIGS. 10A and 10B is terminated.

In FIG. 10A or 10B, when each of the plain transfer control units 128a through 128d receives a notice of completion of receiving of plain data from the printer 13, each of the plain transfer control units 128a through 128d starts transfer processing of plain data of the next page (step S14).

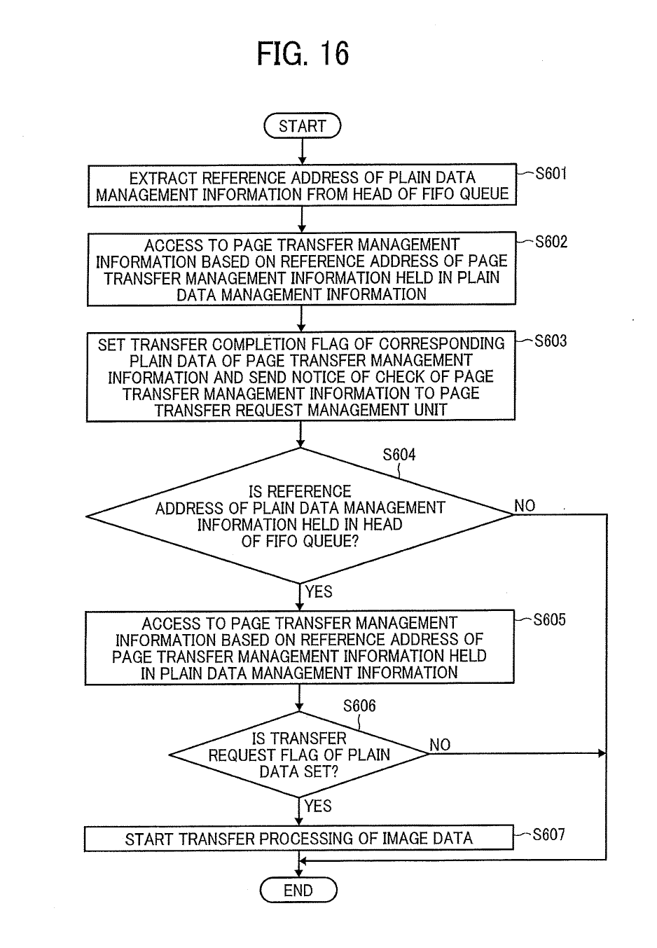

FIG. 16 is a flowchart of a flow of transfer processing of plain data of the next page in the plain transfer control units 128a through 128d in the step S14 of each sequence of FIGS. 10A and 10B.

As illustrated in FIG. 16, each of the plain transfer control units 128a through 128d retrieves the reference address of the plain-data management information 70 from the head of the FIFO queue (step S601).

Next, each of the plain transfer control units 128a through 128d accesses to the page transfer management information 60 according to the reference address of the page transfer management information 60 held in the plain-data management information 70 (step S602).

Next, each of the plain transfer control units 128a through 128d sets the transfer completion flag of the corresponding plain data of the page transfer management information 60 and sends a notice of check of the page transfer management information 60 to the page transfer request management unit 127 (step S603).

Next, each of the plain transfer control units 128a through 128d checks whether the reference address of the plain-data management information 70 is held in the head of the data structure of the FIFO queue (step S604).

Next, when the reference address of the plain-data management information 70 is held in the head of the data structure of the FIFO queue (YES at the step S604), each of the plain transfer control units 128a through 128d accesses to the page transfer management information 60 according to the reference address of the page transfer management information 60 held in the plain-data management information 70 (step S605).

Note that when the reference address of the plain-data management information 70 is not held in the head of the data structure of the FIFO queue (NO at the step S604), each of the plain transfer control units 128a through 128d terminates the processing.

Next, each of the plain transfer control units 128a through 128d checks the transfer request flag of the page transfer management information 60 (step S606).

When the transfer request flag of the page transfer management information 60 is “0” (NO at the step S606), each of the plain transfer control units 128a through 128d terminates the processing.

Alternatively, when the transfer request flag of the page transfer management information 60 is “1” (YES at the step S606), each of the plain transfer control units 128a through 128d starts the transfer processing of image data (step S607).

Thus, the transfer processing of plain data of the next page in the plain transfer control units 128a through 128d in the step S14 of each sequence of FIGS. 10A and 10B ends.

In FIG. 10A or 10B, the page transfer request management unit 127 executes check processing of the page transfer management information 60 (step S15). When the transfer of all plain data of the corresponding page is completed, the page transfer request management unit 127 sends a notice of completion of transfer to the device control request management unit 126 (step S16) and terminates the processing.

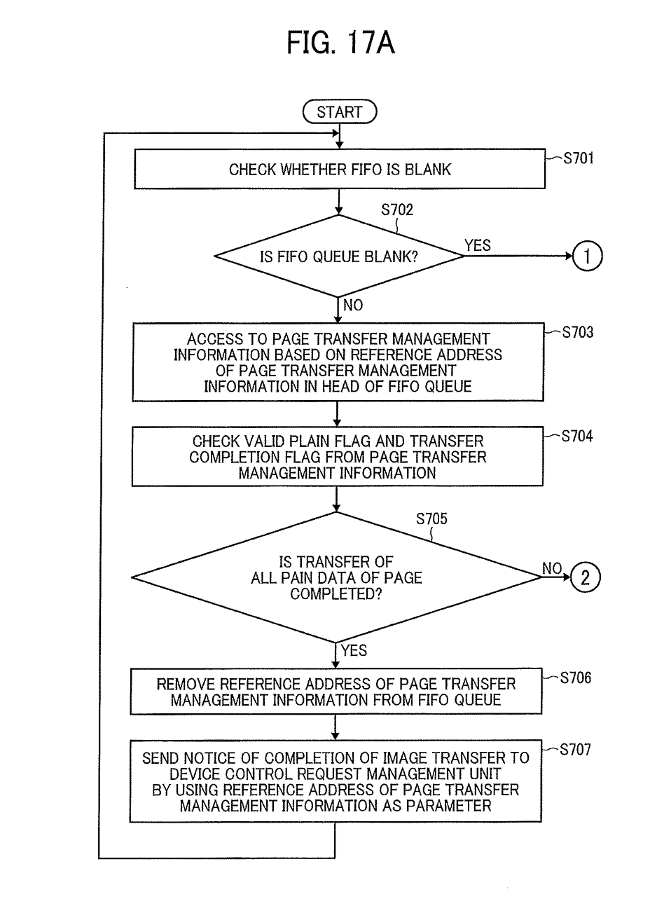

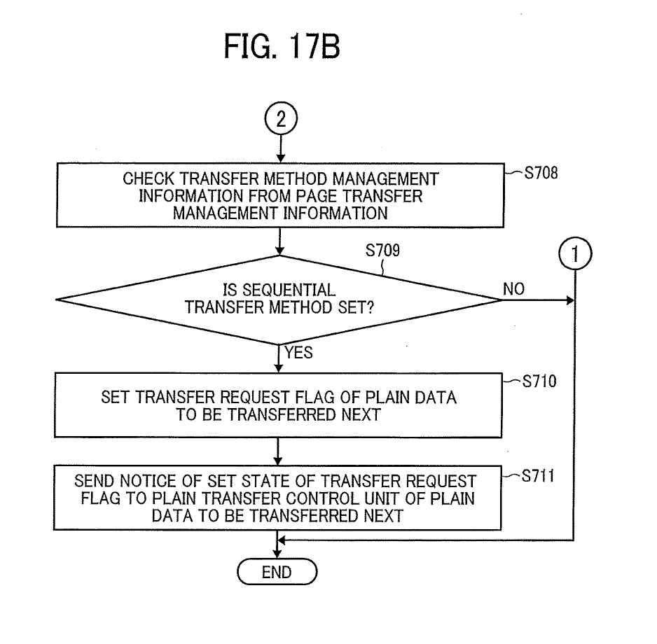

FIGS. 17A and 17B illustrate a flowchart of a flow of processing in the page transfer request management unit 127 in the steps S15 and S16 of each sequence of FIGS. 10A and 10B.

As illustrated in FIG. 17A, the page transfer request management unit 127 checks whether the FIFO queue is blank (step S701). When the FIFO queue is blank (YES at the step S702), the page transfer request management unit 127 terminates the processing.

When the FIFO queue is not blank (NO at step S702), the page transfer request management unit 127 accesses the page transfer management information 60 according to the reference address of the page transfer management information 60 in the head of the FIFO queue (step S703).

Next, the page transfer request management unit 127 checks the valid plain flag and the transfer completion flag from the page transfer management information 60 (step S704).

When all transfer completion flags are “1”, the page transfer request management unit 127 determines that the transfer of all plain data of the corresponding page are completed (YES at step S705) and removes the reference address of the page transfer management information 60 from the FIFO queue (step S706).

Next, the page transfer request management unit 127 sends a notice of completion of image transfer to the device control request management unit 126 by referring to the reference address of the page transfer management information 60 as a parameter (step S707), and returns to the step S701.

Alternatively, when at least one of the transfer completion flags is not “1”, the page transfer request management unit 127 determines that the transfer of all plain data of the corresponding page is not completed (NO at the step S705), and checks the transfer method management information from the page transfer management information 60 (step S708).

When the transfer method management information is “1” indicating the serial transfer method (YES at step S709), the page transfer request management unit 127 sets the transfer request flag of plain data to be transferred next (step S710).

The page transfer request management unit 127 sends a notice of a set state of the transfer request flag to the plain transfer control units 128a through 128d of plain data to be transferred next (step S711).

Such control is performed to prevent plain data constituting the page from being mixed during transfer when the control device 10 is connected to the printer 13 via the single data line 11s.

Alternatively, when the transfer method management information is “0” indicating the parallel transfer method (NO at the step S709), the page transfer request management unit 127 directly terminates the processing.

Such control is performed to allow high-speed data transfer since plain data for respective pages can be sent in parallel when the control device 10 is connected to the printer 13 via the plurality of data lines 11a to 11d.

As described above, according to the present embodiment, checking the transfer method management information of the page transfer management information 60 allows control of the transfer processing according to the serial transfer method of executing transfer control of plain data in unit of page or the transfer processing according to the parallel transfer method of executing independent parallel transfer controls for respective pieces of plain data. Such a configuration can switch the serial transfer method and the parallel transfer method by only changing the transfer method management information (flag) set for switching the serial transfer method and the parallel transfer method, without changing the structure of a processing mechanism for transfer control.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A control device connectable to an image forming apparatus, the control device comprising circuitry to:
generate a plurality of pieces of plain data corresponding to a plurality of colors of one page, which is to be processed in the image forming apparatus, according to image data transferred from a higher-level device, the control device connectable to the image forming apparatus via a single communication path or a plurality of communication paths corresponding to the plurality of colors;
send the plurality of pieces of plain data to the image forming apparatus;
set, as transfer method management information, either a serial transfer method of executing transfer control of the plurality of pieces of plain data in unit of page through the single communication path or a parallel transfer method of executing independent parallel transfer controls for the plurality of pieces of plain data through the plurality of communication paths, according to information on which of the single communication path and the plurality of communication paths connects the control device to the image forming apparatus;
set a transfer request flag of one piece of the plurality of pieces of plain data to a transfer requesting state when the serial transfer method is set as the transfer method management information and to set transfer request flags of all pieces of the plurality of pieces of plain data to the transfer requesting state when the parallel transfer method is set as the transfer method management information; and
control transfer of one piece or all pieces of the plurality of pieces of plain data from the control device to the image forming apparatus according to a set state of the transfer request flags.

2. The control device according to claim 1,
wherein the circuitry specifies the information on which of the single communication path and the plurality of communication paths connects the control device to the image forming apparatus, according to information exchange with the image forming apparatus in start-up.

3. The control device according to claim 1,
wherein the circuitry sets the transfer request flag of one piece of the plurality of pieces of plain data to the transfer requesting state by receiving, as a trigger, a request in unit of one piece of plain data from the image forming apparatus when the serial transfer method is set as the transfer method management information.

4. The control device according to claim 1, wherein the circuitry sets the transfer request flag of one piece of the plurality of pieces of plain data to the transfer requesting state in a predetermined transfer order by receiving, as a trigger, a request in unit of page from the image forming apparatus when the serial transfer method is set as the transfer method management information.

5. The control device according to claim 1, wherein the circuitry manages page transfer management information including the transfer method management information and the transfer request flags according to a data structure of a first-in first-out (FIFO) queue.

6. An image forming system comprising:
the control device according to claim 1; and
the image forming apparatus connected to the control device, to output an image according to the plurality of pieces of plain data transferred from the control device.

7. A method of controlling a control device connected to an image forming apparatus, the method comprising:
generating a plurality of pieces of plain data corresponding to a plurality of colors of one page, which is to be processed in the image forming apparatus, according to image data transferred from a higher-level device, the control device connectable to the image forming apparatus via a single communication path or a plurality of communication paths corresponding to the plurality of colors;
sending the plurality of pieces of plain data to the image forming apparatus;
setting, as transfer method management information, either a serial transfer method of executing transfer control of the plurality of pieces of plain data in unit of page through the single communication path or a parallel transfer method of executing independent parallel transfer controls for the plurality of pieces of plain data through the plurality of communication paths, according to information on which of the single communication path and the plurality of communication paths connects the control device to the image forming apparatus;
setting a transfer request flag of one piece of the plurality of pieces of plain data to a transfer requesting state when the serial transfer method is set as the transfer method management information;
setting transfer request flags of all pieces of the plurality of pieces of plain data to the transfer requesting state when the parallel transfer method is set as the transfer method management information; and
controlling transfer of one piece or all pieces of the plurality of pieces of plain data from the control device to the image forming apparatus according to a set state of the transfer request flags.

8. The method according to claim 7, further comprising specifying the information on which of the single communication path and the plurality of communication paths connects the control device to the image forming apparatus, according to information exchange with the image forming apparatus in start-up.

9. The method according to claim 7, wherein the setting of the transfer request flag includes setting the transfer request flag of one piece of the plurality of pieces of plain data to the transfer requesting state by receiving, as a trigger, a request in unit of one piece of plain data from the image forming apparatus when the serial transfer method is set as the transfer method management information.

10. The method according to claim 7, wherein the setting of the transfer request flag includes setting the transfer request flag of one piece of the plurality of pieces of plain data to the transfer requesting state in a predetermined transfer order by receiving, as a trigger, a request in unit of page from the image forming apparatus when the serial transfer method is set as the transfer method management information.

11. The method according to claim 7, further comprising managing page transfer management information including the transfer method management information and the transfer request flags according to a data structure of a first-in first-out (FIFO) queue.

12. A recording medium storing program codes that cause a computer to perform a method of controlling a control device connected to an image forming apparatus, the method comprising:
generating a plurality of pieces of plain data corresponding to a plurality of colors of one page, which is to be processed in the image forming apparatus, according to image data transferred from a higher-level device, the control device connectable to the image forming apparatus via a single communication path or a plurality of communication paths corresponding to the plurality of colors;
sending the plurality of pieces of plain data to the image forming apparatus;
setting, as transfer method management information, either a serial transfer method of executing transfer control of the plurality of pieces of plain data in unit of page through the single communication path or a parallel transfer method of executing independent parallel transfer controls for the plurality of pieces of plain data through the plurality of communication paths, according to information on which of the single communication path and the plurality of communication paths connects the control device to the image forming apparatus;
setting a transfer request flag of one piece of the plurality of pieces of plain data to a transfer requesting state when the serial transfer method is set as the transfer method management information;
setting transfer request flags of all pieces of the plurality of pieces of plain data to the transfer requesting state when the parallel transfer method is set as the transfer method management information; and
controlling transfer of one piece or all pieces of the plurality of pieces of plain data from the control device to the image forming apparatus according to a set state of the transfer request flags.
